(19) United States
(12) Patent Application Publication
(10) Pub. No.: US 2021/0182789 A1
(43) Pub. Date: Jun. 17, 2021

(54) DETERMINATION OF BUSINESS COVERAGE AREA

(71) Applicant: Beijing Sankuai Online Technology Co., Ltd, Beijing (CN)

(72) Inventors: Rui YIN, Beijing (CN); Xuetao DING, Beijing (CN); Ke XING, Beijing (CN); Zhengang GUO, Beijing (CN)

(21) Appl. No.: 16/759,725

(22) PCT Filed: Dec. 19, 2018
(86) PCT No.: PCT/CN2018/122080

§ 371 Date: Apr. 27, 2020

(30) Foreign Application Priority Data
Jun. 28, 2018 (CN) 201810691297.9

(51) Int. Cl. G06Q 10/08; G06Q 10/06; G06Q 10/04

(52) U.S. Cl. CPC G06Q 10/08355; G06Q 10/04; G06Q 10/06315; G06Q 10/0875

(57) ABSTRACT

A method for determining a service coverage area is provided. In an embodiment, the method includes: determining a trigger condition corresponding to each of a plurality of preset service scenarios for a target supplier; if it is determined that the trigger condition corresponding to any one of the service scenarios is satisfied, determining a target area corresponding to the target supplier in the service scenario; and switching a service coverage area of the target supplier to the target area.

### CROSS-REFERENCE TO RELATED APPLICATIONS

This patent application claims priority to Chinese Patent Application No. 201810691297.9, filed on Jun. 28, 2018 and entitled “Method and Apparatus for Determining Service coverage Area, and Electronic Device”, the entire contents of which are incorporated herein by reference.

### TECHNICAL FIELD

This application relates to determination of a service coverage area in the technical field of the Internet.

### BACKGROUND

With the continuous development of an Internet technology, Internet-based services have emerged. An instant delivery service is taken as an example. A fixed service coverage area is usually set for each supplier. In a service coverage area corresponding to any supplier, customers can establish service relationships with the supplier (for example, customers can purchase goods provided by the supplier, etc.). At present, the demand for delivery resources by instant delivery services is not fixed and usually fluctuates, thereby making it difficult to maintain a balanced state between the supply and demand of delivery resources.

### SUMMARY

In view of this, this application provides a method and apparatus for determining a service coverage area, and an electronic device.

According to a first aspect of embodiments of this application, a method for determining a service coverage area is provided. The method includes:

determining a trigger condition corresponding to each of a plurality of preset service scenarios for a target supplier;

if it is determined that the trigger condition corresponding to any one of the service scenarios is satisfied, determining a target area corresponding to the target supplier in the service scenario; and

switching a service coverage area of the target supplier to the target area.

According to a second aspect of the embodiments of this application, an apparatus for determining a service coverage area is provided. The apparatus includes:

a condition determining module, configured to determine a trigger condition corresponding to each of a plurality of preset service scenarios for a target supplier;

an area determining module, configured to determine, if it is determined that the trigger condition corresponding to any one of the service scenarios is satisfied, a target area corresponding to the target supplier in the service scenario; and

a switching module, configured to switch a service coverage area of the target supplier to the target area.

According to a third aspect of the embodiments of this application, a computer-readable storage medium is provided. The storage medium stores a computer program that, when executed by a processor, implements the method described in the first aspect.

According to a fourth aspect of the embodiments of this application, an electronic device is provided. The electronic device includes a memory, a processor, and a computer program stored on the memory and executable on the processor. When the processor executes the program, the method described in the first aspect is implemented.

According to the method for determining a service coverage area provided by the embodiments of this application, a trigger condition corresponding to each of a plurality of preset service scenarios is determined for a target supplier, when it is determined that the trigger condition corresponding to any one of the service scenarios is satisfied, a target area corresponding to the target supplier in the service scenario is determined, and a service coverage area of the target supplier is switched to the target area. Therefore, in different service scenarios, a service coverage area of a target supplier can be switched to a different area, so that a relationship between the supply and demand of delivery resources is adjusted by adjusting a service coverage range of the target supplier, thereby maintaining a relatively balanced state between the supply and demand of the delivery resources, and contributing to improving the service efficiency of the delivery resources and the utilization rate of the delivery resources.

It should be understood that the above general descriptions and the following detailed descriptions are merely for exemplary and explanatory purposes, and cannot limit this application.

### BRIEF DESCRIPTION OF THE DRAWINGS

The accompanying drawings, which are incorporated herein and constitute a part of this specification, illustrate embodiments consistent with this application and, together with the specification, serve to explain the principles of this application.

FIG. 1 is a flowchart of a method for determining a service coverage area according to an exemplary embodiment of this application.

FIG. 2 is a flowchart of a method for determining a service coverage area according to another exemplary embodiment of this application.

FIG. 3 is a schematic scenario diagram of determination of a service coverage area according to an exemplary embodiment of this application.

FIG. 4 is a flowchart of a method for determining a service coverage area according to another exemplary embodiment of this application.

FIG. 5 is a block diagram of an apparatus for determining a service coverage area according to an exemplary embodiment of this application.

FIG. 6 is a block diagram of an apparatus for determining a service coverage area according to another exemplary embodiment of this application.

FIG. 7 is a schematic structure diagram of an electronic device according to an exemplary embodiment of this application.

### DETAILED DESCRIPTION OF THE EMBODIMENTS

Exemplary embodiments are described in detail herein, and examples of the exemplary embodiments are shown in the accompanying drawings. When the following descriptions relate to the accompanying drawings, unless indicated otherwise, same numbers in different accompanying drawings represent same or similar elements. The implementations described in the following exemplary embodiments do not represent all implementations consistent with this application. On the contrary, the implementations are merely examples of apparatuses and methods that are described in detail in the appended claims and that are consistent with some aspects of this application.

The terms used in this application are merely for the purpose of describing specific embodiments, and are not intended to limit this application. The terms “a”, “said” and “the” of singular forms used in this application and the appended claims are also intended to include plural forms, unless otherwise specified in the context clearly. It should also be understood that, the term “and/or” used herein indicates and includes any or all possible combinations of one or more associated listed items.

It should be understood that although the terms such as first, second, and third may be used herein to describe various information, such information should not be limited to these terms. These terms are merely used for distinguishing information of the same type from each other. For example, within the scope of this application, first information may also be referred to as second information, and similarly, second information may also be referred to as first information. Depending on the context, the term “if” as used herein may be interpreted as “when . . . ” or “upon . . . ” or “in response to determining.”

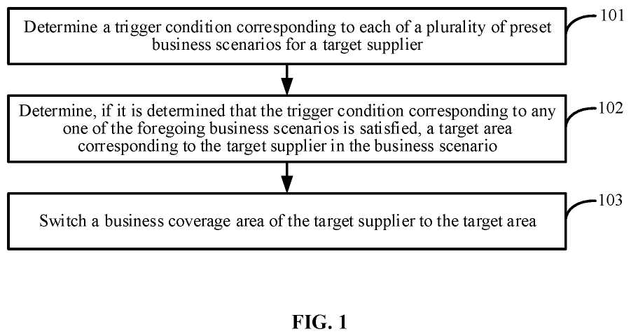

As shown in FIG. 1, FIG. 1 is a flowchart of a method for determining a service coverage area according to an exemplary embodiment. The method may be applied to a server. The method includes the following steps.

In step 101, a trigger condition corresponding to each of a plurality of preset service scenarios is determined for a target supplier.

In an embodiment, the target supplier may be a merchant (such as a restaurant, a supermarket, or a flower shop) that provides goods, or a warehouse for shipment. The specific type of the target supplier is not limited in this application.

In an embodiment, a plurality of service scenarios may be set in advance. For the target supplier, any one of the service scenarios corresponds to a trigger condition. The trigger condition is a condition that triggers switching to the service scenario. At least two preset service scenarios may be included. The specific number of the preset service scenarios is not limited in this application. A service scenario and a corresponding trigger condition may be set based on a preset factor. The preset factor may be one or more factors that affect the demand for delivery resources, so that the divided service scenarios can better reflect different demands for delivery resources.

In an embodiment, the preset service scenarios may include a first service scenario and a second service scenario. A first trigger condition corresponding to the first service scenario and a second trigger condition corresponding to the second service scenario are determined according to a first curve. The first curve is a curve of a load of a delivery resource for a service order in a preset management area where the target supplier is located over time. Therefore, the first service scenario and the second service scenario may be scenarios divided based on a relationship between the number of service orders and a time period. For example, the first service scenario corresponds to a time period with a small number of service orders, and the second service scenario corresponds to a time period with a large number of service orders. The preset management area may be divided into a plurality of areas for suppliers in advance for the convenience of management. Each preset management area may include a plurality of suppliers. It can be understood that the preset management area may be divided in any reasonable manner. The specific manner of dividing the preset management area is not limited in this application.

In another embodiment, the preset service scenarios may include a third service scenario in addition to the first service scenario and the second service scenario. A third trigger condition corresponding to the third service scenario may be that a preset instruction is received. The third service scenario may be a scenario divided based on a special situation. For example, when the weather is bad (such as strong wind, or heavy rain, or snow), or when a major event (such as a large entertainment event, or an important meeting) is held in a certain area within a certain time period, the service efficiency of delivery resources may be affected due to environment or traffic control, thereby affecting the demand for delivery resources. Therefore, a user (such as a delivery resource manager) may perform a preset scenario opening operation to send a preset instruction for instructing to open the third service scenario. In response to receiving the preset instruction, it is determined that the third trigger condition corresponding to the third scenario is satisfied.

It can be understood that a plurality of service scenarios and their corresponding trigger conditions may also be divided in other manners. The specific division of the service scenarios and their corresponding trigger conditions is not limited in this application.

In step 102, if it is determined that the trigger condition corresponding to any one of the foregoing service scenarios is satisfied, a target area corresponding to the target supplier in the service scenario is determined.

In an embodiment, when it is determined that the trigger condition corresponding to any one of the foregoing service scenarios is satisfied, a target area corresponding to the target supplier in the service scenario can be determined.

Specifically, firstly, a target area corresponding to the target supplier in each service scenario may be determined in advance, and each determined target area may be stored in association with a corresponding service scenario and the target supplier. For any one service scenario, in the target area corresponding to the target supplier in the service scenario, the supply and demand of delivery resources can be maintained in a relatively balanced state.

Then, when it is determined that the trigger condition corresponding to any one service scenario is satisfied, a target area (that is, the target area corresponding to the target supplier in the service scenario) associated with the target supplier and the service scenario may be taken from pre-stored data.

In an embodiment, for any one service scenario, a target area corresponding to the target supplier in the service scenario may be acquired in advance in the following manners: firstly, determining a target distance corresponding to the target supplier in the service scenario; and then, determining a target area corresponding to the target supplier in the service scenario based on the target distance.

In an embodiment, for any one service scenario, a target area corresponding to the target supplier in the service scenario may also be acquired in advance in the following manners: firstly, dividing a plurality of candidate areas for the target supplier; and then, selecting, based on historical service data, an area where the target supplier has an optimal index in the service scenario from the plurality of candidate areas as a target area corresponding to the target supplier in the service scenario. The preset index may be any index that can reflect the service efficiency of delivery resources and/or the utilization rate of delivery resources. The specific content of the preset index is not limited in this application.

It can be understood that any other reasonable manner may also be used to acquire a target area corresponding to a target supplier in each service scenario in advance, which is not limited in this application.

In step 103, a service coverage area of the target supplier is switched to the target area.

In an embodiment, the service coverage area of the target supplier may be an effective range capable of establishing a service service relationship with the target supplier. For example, a customer-side client inside the service coverage area may obtain supply information of the target supplier and can generate a service order for the target supplier. A customer-side client outside the service coverage area cannot obtain supply information of the target supplier and cannot generate a service order for the target supplier.

In an embodiment, if it is determined that the trigger condition corresponding to any one service scenario is satisfied, a target area corresponding to the target supplier in the service scenario is determined, and a service coverage area of the target supplier is switched to the target area. For example, for a target supplier, when it is determined that a trigger condition corresponding to a service scenario is satisfied, a target area corresponding to the target supplier in the service scenario may be used as a service coverage area of the target supplier starting from now until trigger conditions corresponding to other service scenarios are satisfied.

According to the method for determining a service coverage area provided by the foregoing embodiment of this application, a trigger condition corresponding to each of a plurality of preset service scenarios is determined for a target supplier, when it is determined that the trigger condition corresponding to any one of the service scenarios is satisfied, a target area corresponding to the target supplier in the service scenario is determined, and a service coverage area of the target supplier is switched to the target area. Therefore, in different service scenarios, a service coverage area of a target supplier can be switched to a different area, so that a relationship between the supply and demand of delivery resources is adjusted by adjusting a service coverage range of the target supplier, thereby maintaining a relatively balanced state between the supply and demand of the delivery resources, and contributing to improving the service efficiency of the delivery resources and the utilization rate of the delivery resources.

It should be noted that in general, delivery resources are generally managed by using a preset management area as a unit. Therefore, a relationship between the supply and demand of delivery resources is also calculated by using a preset management area as a unit. Each preset management area includes a plurality of suppliers, and the supply and demand of delivery resources are also different for each supplier. Therefore, those skilled in the art have not found that setting a fixed service coverage area for each supplier is one of the reasons why it is difficult to maintain a balanced state between the supply and demand of delivery resources. The technical solution of this application takes this into consideration. Therefore, this application also solves the technical problem that it is difficult to maintain a balanced state between the supply and demand of delivery resources through the discovery of the problem.

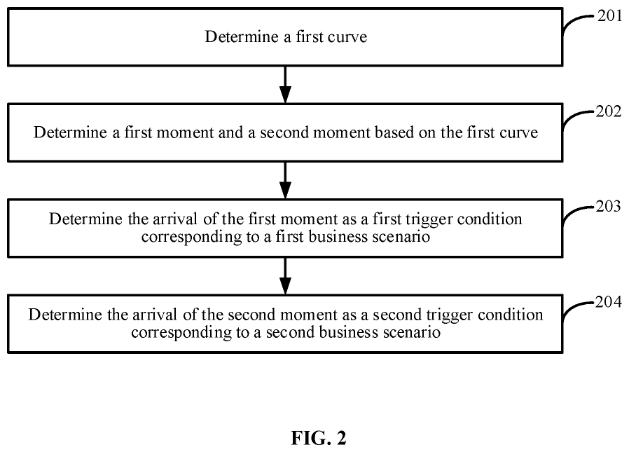

As shown in FIG. 2, FIG. 2 is a flowchart of a method for determining a service coverage area according to another exemplary embodiment. The embodiment describes the process of determining trigger conditions corresponding to a first service scenario and a second service scenario. The method may be applied to a server, and may include the following steps.

In step 201, a first curve is determined.

In an embodiment, the first curve is a curve of a load of a delivery resource for a service order in a preset management area where the target supplier is located over time. The load of the delivery resource for the service order may be an average number of service orders for each distributor. Specifically, historical service data (such as service data of the past week or service data of the past month) in a preset management area where the target supplier is located may be acquired, and the historical service data may be statistically calculated to fit a curve of a load of a delivery resource for a service order in the preset management area where the target supplier is located over time as a first curve.

In step 202, a first moment and a second moment are determined based on the first curve.

In an embodiment, since the first curve may change periodically and a period/circle is generally one day, a curve of a period (one day) may be taken, and the first moment and the second moment may be determined based on the first curve. The first moment may be a moment at which a load is smaller than a preset threshold for the first time after a preset moment in the first curve. The second moment may be a moment at which the load is greater than the preset threshold for the first time after the first moment in the first curve.

In an embodiment, the preset moment may include a moment or a plurality of moments. For example, the preset moment may include only a noon peak moment (that is, a moment when a noon load is the largest), or may include both a noon peak moment and an evening peak moment (that is, a moment when a night load is the largest). It can be understood that it is not limited in this application.

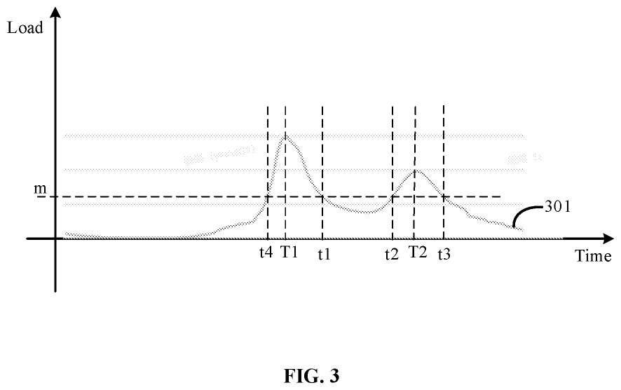

As shown in FIG. 3, curve 301 is a first curve during a day. The abscissa is the moment, and the ordinate is the load. T1 is the noon peak moment, and T2 is the evening peak moment. It should be noted that the load of the delivery resource for the service order in the preset management area where the target supplier is located changes continuously with moment. FIG. 3 only shows the change of the load with moment during a day. In an embodiment, T1 may be taken as a preset moment. Moment t1 at which a load is smaller than a preset threshold m for the first time after T1 may be taken as a first moment. Moment t2 at which the load is greater than the preset threshold m for the first time after t1 may be taken as a second moment. In another embodiment, T1 and T2 may be both taken as a preset moment. Moment t1 and moment t3 at which a load is smaller than the preset threshold m for the first time after T1 and T2 may be taken as a first moment respectively. Moment t2 and moment t4 at which the load is greater than the preset threshold m for the first time after t1 and t3 may be taken as a second moment respectively.

In an embodiment, the foregoing preset threshold may be determined in the following manners: firstly, fitting a second curve based on historical service data in the preset management area where the target supplier is located, the second curve being a relationship curve between a load of a delivery resource for a service order and a delivery duration, where the second curve may be a curve in any form, and the specific form of the second curve is not limited in this application; and then, a load corresponding to the first delivery duration in the second curve is determined as the foregoing preset threshold. The first delivery duration may represent a maximum acceptable delivery duration. Therefore, the first delivery duration may be any reasonable value. The specific value of the first delivery duration is not limited in this application.

It can be understood that the foregoing preset threshold may also be determined in other manners. For example, a reasonable value may be directly taken as the foregoing preset threshold based on experience, which is not limited in this application.

In step 203, the arrival of the first moment is determined as the first trigger condition corresponding to the first service scenario.

In step 204, the arrival of the second moment is determined as the second trigger condition corresponding to the second service scenario.

In an embodiment, “arrival of the first moment” may be set as a first trigger condition corresponding to the first service scenario, and “arrival of the second moment” may be set as a second trigger condition corresponding to the second service scenario. In the arrival of the first moment, it may be determined that the first trigger condition corresponding to the first service scenario is satisfied. In the arrival of the second moment, it may be determined that the second trigger condition corresponding to the second service scenario is satisfied.

According to the method for determining a service coverage area provided by the foregoing embodiment of this application, a first trigger condition corresponding to a first service scenario and a second trigger condition corresponding to a second service scenario are set through a first curve of a load of a delivery resource for a service order in a preset management area where a target supplier is located over time. Since the load of the delivery resource for the service order can better reflect different demands for the delivery resource, the foregoing trigger condition set based on the first curve is more reasonable.

In an embodiment, a target area corresponding to the target supplier in the first service scenario is larger than a target area corresponding to the target supplier in the second service scenario. It can be known from the foregoing embodiment that the first service scenario can better reflect the situation that the demand for delivery resources is smaller (the utilization rate of delivery resources is small), and the second service scenario can better reflect the situation that the demand for delivery resources is greater (the utilization rate of delivery resources is great). When the demand for delivery resources is smaller, by expanding the area of the service coverage area, the demand for delivery resources can be increased, and also, the utilization rate of delivery resources is improved.

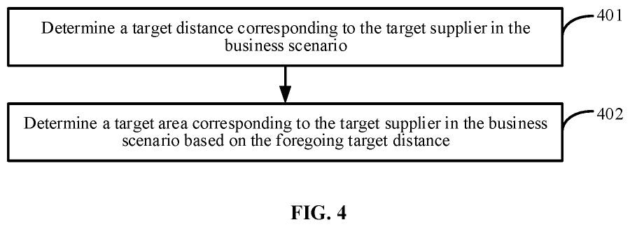

As shown in FIG. 4, FIG. 4 is a flowchart of a method for determining a service coverage area according to another exemplary embodiment. The embodiment describes the process of determining, for any one of the service scenarios, a target area corresponding to the target supplier in the service scenario. The method may be applied to a server, and may include the following steps.

In step 401, a target distance corresponding to the target supplier in the service scenario is determined.

In an embodiment, if the service scenario is a first service scenario, a target distance corresponding to the target supplier in the first service scenario may be determined in the following manners: firstly, fitting a third curve based on historical service data in the preset management area where the target supplier is located, the third curve being a relationship curve between a delivery duration and a delivery distance, where the third curve may be a curve in any form and the specific form of the third curve is not limited in this application; and then, determining a delivery distance corresponding to a first delivery duration in the third curve as a target distance corresponding to the target supplier in the first service scenario. The first delivery duration may represent a maximum acceptable delivery duration. Therefore, the first delivery duration may be any reasonable value. The specific value of the first delivery duration is not limited in this application.

In another embodiment, if the service scenario is a second service scenario, a target distance corresponding to the target supplier in the second service scenario may be determined in the following manners: firstly, fitting a third curve based on historical service data in the preset management area where the target supplier is located; and then, determining a delivery distance corresponding to a second delivery duration in the third curve as a target distance corresponding to the target supplier in the second service scenario. The second delivery duration may represent an optimal delivery duration, which is the shortest delivery duration that can be achieved. The foregoing first delivery duration is greater than the second delivery duration. The second delivery duration may be any reasonable value. The specific value of the second delivery duration is not limited in this application.

In yet another embodiment, if the service scenario is a third service scenario, a target distance corresponding to the target supplier in the third service scenario may be determined in the following manners: firstly, obtaining a fourth curve based on historical service data in the preset management area where the target supplier is located, the fourth curve being a cumulative delivery function (CDF) curve of the load of a delivery resource for a service order over a delivery distance; and then, determining a delivery distance corresponding to a preset load in the fourth curve as a target distance corresponding to the target supplier in the third service scenario. It should be noted that because the third service scenario is a scenario divided based on a special situation, under the same load, the service efficiency of delivery resources in the third service scenario will be smaller. Therefore, the efficiency can be improved by reducing the load. Based on the historical service data in the preset management area where the target supplier is located, an optimal load of the delivery resource for the service order may be determined, and a preset load may be set based on the optimal load, so that the optimal load is greater than the preset load. The preset duration may be any reasonable value. The specific value of the preset duration is not limited in this application.

In step 402, a target area corresponding to the target supplier in the service scenario is determined based on the foregoing target distance.

In an embodiment, a target area corresponding to the target supplier in the service scenario may be determined based on the foregoing target distance. In an embodiment, a plurality of target points may be selected around the target supplier. A navigation distance between each target point and the target supplier is the foregoing target distance. Then, adjacent target points are connected to encircle a target area corresponding to the target supplier in the service scenario.

In another embodiment, a circular area may also be obtained with the target supplier as a center and the target distance as a radius. The circular area is taken as a target area corresponding to the target supplier in the service scenario.

It can be understood that any other reasonable manner may also be used to determine a target area corresponding to the target supplier in the service scenario. The specific manner of determining the target area corresponding to the target supplier in the service scenario is not limited in this application.

According to the method for determining a service coverage area provided by the foregoing embodiment of this application, for any one service scenario, a target distance corresponding to a target supplier in the service scenario is determined, and a target area corresponding to the target supplier in the service scenario is determined based on the target distance. Therefore, the target area corresponding to the target supplier in the service scenario can be more reasonable.

It should be noted that although the operations of the method of this application are described in a specific order in the foregoing embodiment, this does not require or imply that these operations must be performed in the specific order, or that all of the operations shown must be performed to achieve the expected results. Instead, the steps depicted in the flowchart may be executed in a different sequence. Additionally or alternatively, certain steps may be omitted, a plurality of steps may be combined into one step for execution, and/or one step may be split into a plurality of steps for execution.

In the following, a complete application example of determining a service coverage area is used to schematically illustrate the solution of this application.

The application scenario may be: a first service scenario, a second service scenario, and a third service scenario may be set in advance. The first service scenario corresponds to a time period with a small number of orders in a day, the second service scenario corresponds to a time period with a large number of orders in a day, and the third service scenario corresponds to a time period when the weather is bad or a major event is held. Moreover, for any supplier, the first trigger condition of the first service scenario is set to “arrival of the first moment”, the second trigger condition of the second service scenario is set to “arrival of the second moment”, and the third trigger condition of the third service scenario is set to “receiving of a preset instruction from a user”.

Then, for each supplier, target areas corresponding to the first service scenario, the second service scenario, and the third service scenario are respectively set and stored in association. The first target area corresponding to the first service scenario is larger than the second target area corresponding to the second service scenario, and the target area corresponding to the second service scenario is larger than the third target area corresponding to the third service scenario.

For any supplier, when arrival of the first moment corresponding to the supplier is determined, it may be determined that the first trigger condition of the first service scenario is satisfied. A service coverage area of the supplier may be switched to a first target area corresponding to the supplier in the first service scenario. When arrival of the second moment corresponding to the supplier is determined, it may be determined that the second trigger condition of the second service scenario is satisfied. A service coverage area of the supplier may be switched to a second target area corresponding to the supplier in the second service scenario. When a preset instruction is received from a user, it may be determined that the third trigger condition of the third service scenario is satisfied. A service coverage area of the supplier may be switched to a third target area corresponding to the supplier in the third service scenario.

Hence, with the foregoing solution, for any supplier, during the time period with a small number of orders in a day, the range of a service coverage area of the supplier is expanded. During the time period with a large number of orders in a day or when the service efficiency is reduced, the range of the service coverage area of the supplier is reduced, thereby maintaining a relatively balanced state between the supply and demand of delivery resources, and contributing to improving the service efficiency of the delivery resources and the utilization rate of the delivery resources.

Corresponding to the foregoing embodiment of the method for determining a service coverage area, this application further provides an embodiment of an apparatus for determining a service coverage area.

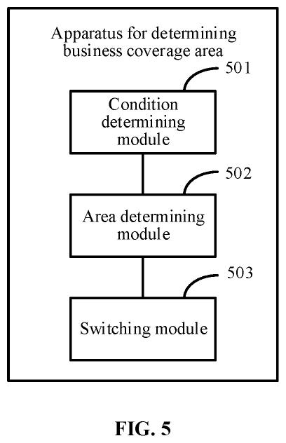

As shown in FIG. 5, FIG. 5 is a block diagram of an apparatus for determining a service coverage area according to an exemplary embodiment of this application. The apparatus may include: a condition determining module 501, an area determining module 502, and a switching module 503.

The condition determining module 501 is configured to determine a trigger condition corresponding to each of a plurality of preset service scenarios for a target supplier.

The area determining module 502 is configured to determine, if it is determined that the trigger condition corresponding to any one of the foregoing service scenarios is satisfied, a target area corresponding to the target supplier in the service scenario.

The switching module 503 is configured to switch a service coverage area of the target supplier to the target area of the target supplier in the service scenario.

In some embodiments, the foregoing preset service scenarios include a first service scenario and a second service scenario. A first trigger condition corresponding to the first service scenario and a second trigger condition corresponding to the second service scenario are determined according to a first curve. The first curve is a curve of a load of a delivery resource for a service order in a preset management area where the target supplier is located over time.

In some embodiments, the foregoing preset service scenario further includes a third service scenario. A third trigger condition corresponding to the third service scenario is that a preset instruction is received.

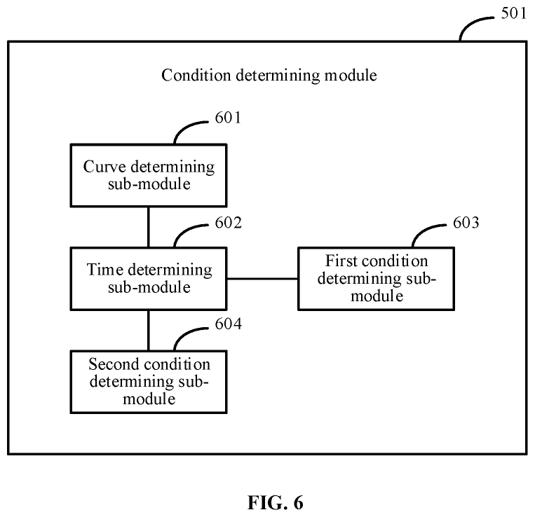

As shown in FIG. 6, FIG. 6 is a block diagram of an apparatus for determining a service coverage area according to another exemplary embodiment of this application. In the embodiment, based on the foregoing embodiment shown in FIG. 5, the condition determining module 501 may include: a curve determining sub-module 601, a moment determining sub-module 602, a first condition determining sub-module 603, and a second condition determining sub-module 604.

The curve determining sub-module 601 is configured to determine the foregoing first curve.

The moment determining sub-module 602 is configured to determine a first moment and a second moment based on the first curve. The first moment is a moment at which a load is smaller than a preset threshold for the first time after a preset moment in the first curve, and the second moment is a moment at which the load is greater than the preset threshold for the first time after the first moment in the first curve.

The first condition determining sub-module 603 is configured to determine the arrival of the first moment as the first trigger condition corresponding to the first service scenario.

The second condition determining sub-module 604 is configured to determine the arrival of the second moment as the second trigger condition corresponding to the second service scenario.

In some embodiments, the foregoing preset threshold may be determined in the following manners: fitting a second curve based on historical service data in the preset management area where the target supplier is located, the second curve being a relationship curve between the foregoing load and a delivery duration; and determining a load corresponding to the first delivery duration in the second curve as the preset threshold.

In some embodiments, a first target area corresponding to the target supplier in the first service scenario is larger than a second target area corresponding to the target supplier in the second service scenario.

In some embodiments, for any one service scenario, a target area corresponding to the target supplier in the service scenario is determined in the following manners: determining a target distance corresponding to the target supplier in the service scenario; and determining a target area corresponding to the target supplier in the service scenario based on the target distance.

In some embodiments, if the service scenario is a first service scenario, a target distance corresponding to the target supplier in the first service scenario may be determined in the following manners: fitting a third curve based on historical service data in the preset management area where the target supplier is located, the third curve being a relationship curve between a delivery duration and a delivery distance; and determining a delivery distance corresponding to a first delivery duration in the third curve as a target distance corresponding to the target supplier in the first service scenario.

In some embodiments, if the service scenario is a second service scenario, a target distance corresponding to the target supplier in the second service scenario may be determined in the following manners: determining a delivery distance corresponding to a second delivery duration in the third curve as a target distance corresponding to the target supplier in the second service scenario, the first delivery duration being greater than the second delivery duration.

In some embodiments, if the service scenario is a third service scenario, a target distance corresponding to the target supplier in the third service scenario may be determined in the following manners: obtaining a fourth curve based on historical service data in the preset management area where the target supplier is located, the fourth curve being a CDF curve of the load over a delivery distance; and determining a delivery distance corresponding to a preset load in the fourth curve as a target distance corresponding to the target supplier in the third service scenario.

In some embodiments, a target area corresponding to the target supplier in the service scenario may be determined based on the target distance in the following manners: selecting a plurality of target points around the target supplier, a navigation distance between each target point and the target supplier being the target distance; and connecting adjacent target points among the plurality of target points to encircle a target area corresponding to the target supplier in the service scenario.

In some embodiments, a target area corresponding to the target supplier in the service scenario may be determined based on the target distance in the following manners: obtaining a circular area with the target supplier as a center and the target distance as a radius; and taking the circular area as the target distance corresponding to the target supplier in the service scenario.

It should be understood that the foregoing apparatus may be provided in a server in advance, or may be loaded into the server by downloading or the like. The corresponding modules in the foregoing apparatus may cooperate with modules in the server to implement a scheme of determining a service coverage area.

The apparatus embodiments basically correspond to the method embodiments, and therefore, reference may be made to the method embodiments for the associated part. The apparatus embodiments described above are merely schematic. The units described as separate parts may be or may not be physically apart. The parts displayed as units may be or may not be physical units, in other words, may be located at a same place, or may be distributed onto a plurality of network units. Some or all of the modules may be selected according to practical requirements to achieve the objectives of this application. A person of ordinary skill in the art may understand and implement the objective without creative efforts.

An embodiment of this application also provides a computer-readable storage medium, storing a computer program, and the computer program can be used to perform the method for determining a service coverage area provided in any of the embodiments in FIG. 1 to FIG. 4.

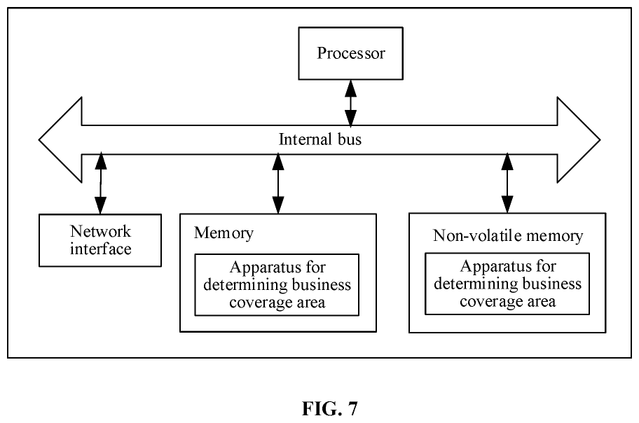

Corresponding to the method for determining a service coverage area described above, an embodiment of this application also provides a schematic structural diagram of an electronic device according to an exemplary embodiment of this application shown in FIG. 7. Referring to FIG. 7, on a hardware level, the electronic device includes a processor, an internal bus, a network interface, a memory, and a non-volatile memory, and may include other hardware required by services. The processor reads a corresponding computer program from the non-volatile memory into the memory and then executes the computer program, to form an apparatus for determining a service coverage area at the logic level. Definitely, in addition to a software implementation, this application does not exclude other implementations, for example, a logic device or a combination of software and hardware. In other words, an entity executing the following processing procedure is not limited to the logic units, and may also be hardware or logic devices.

After considering the specification and practicing the present disclosure, a person skilled in the art would easily conceive of other implementations of this application. This application is intended to cover any variation, use, or adaptive change of this application. These variations, uses, or adaptive changes follow the general principles of this application and include common general knowledge or common technical means in the art that are not disclosed in this application. The specification and the embodiments are considered as merely exemplary, and the real scope and spirit of this application are pointed out in the following claims.

It should be understood that this application is not limited to the precise structures described above and shown in the accompanying drawings, and various modifications and changes can be made without departing from the scope of this application. The scope of this application is limited only by the appended claims.

1. A computer-implemented method for determining a service coverage area, comprising:
determining, by at least one processor a trigger condition corresponding to each of a plurality of preset service scenarios for a target supplier;
in response to determining that the trigger condition corresponding to any one of the service scenarios is satisfied, determining, by at least one processor a target area corresponding to the target supplier in the service scenario; and
switching, by at least one processor a service coverage area of the target supplier to the target area.

2. The method according to claim 1, further comprising:
in response to the preset service scenarios comprising a first service scenario and a second service scenario, determining, by at least one processor and according to a first curve, a first trigger condition corresponding to the first service scenario and a second trigger condition corresponding to the second service scenario, the first curve being a curve of a load of a delivery resource for a service order in a preset area at which the target supplier is located over time.

3. The method according to claim 2, wherein the preset service scenarios further comprise a third service scenario, and a third trigger condition corresponding to the third service scenario is that a preset instruction is received.

4. The method according to claim 2, wherein determining, according to a first curve, a first trigger condition corresponding to the first service scenario and a second trigger condition corresponding to the second service scenario comprises:
determining, by at least one processor the first curve;
determining, by at least one processor, a first moment and a second moment based on the first curve, the first moment being a moment at which a load is smaller than a preset threshold for the first time after a preset moment in the first curve, and the second moment being a moment at which the load is greater than the preset threshold for the first time after the first moment in the first curve;
determining, by at least one processor, arrival of the first moment as the first trigger condition corresponding to the first service scenario; and
determining, by at least one processor, arrival of the second moment as the second trigger condition corresponding to the second service scenario.

5. The method according to claim 4, further comprising:
fitting, by the at least one processor, a second curve based on historical service data in the preset area at which the target supplier is located, the second curve being a relationship curve between the load and a delivery duration; and
determining, by the at least one processor, a load corresponding to the first delivery duration in the second curve as the preset threshold.

6. The method according to claim 4, wherein a first target area corresponding to the target supplier in the first service scenario is larger than a second target area corresponding to the target supplier in the second service scenario.

7. The method according to claim 3, wherein determining a target area corresponding to the target supplier in the service scenario comprises:
determining, by the at least one processor, a target distance corresponding to the target supplier in the service scenario; and
determining, by the at least one processor, a target area corresponding to the target supplier in the service scenario based on the target distance.

8. The method according to claim 7, wherein determining a target distance corresponding to the target supplier in the first service scenario comprises:
fitting, by the at least one processor, a third curve based on historical service data in the preset area at which the target supplier is located, the third curve being a relationship curve between a delivery duration and a delivery distance; and
determining, by the at least one processor, a delivery distance corresponding to a first delivery duration in the third curve as a target distance corresponding to the target supplier in the first service scenario.

9. The method according to claim 8, wherein determining a target distance corresponding to the target supplier in the second service scenario comprises:
determining, by the at least one processor, a delivery distance corresponding to a second delivery duration in the third curve as a target distance corresponding to the target supplier in the second service scenario, the first delivery duration being greater than the second delivery duration.

10. The method according to claim 7, wherein determining a target distance corresponding to the target supplier in the third service scenario comprises:
obtaining, by the at least one processor, a fourth curve based on historical service data in the preset area at which the target supplier is located, the fourth curve being a cumulative delivery function (CDF) curve of the load over a delivery distance; and
determining, by the at least one processor, a delivery distance corresponding to a preset load in the fourth curve as a target distance corresponding to the target supplier in the third service scenario.

11. The method according to claim 7, wherein determining a target area corresponding to the target supplier in the service scenario based on the target distance comprises:
selecting, by the at least one processor, a plurality of target points around the target supplier, a navigation distance between each target point and the target supplier being the target distance; and
connecting, by the at least one processor, adjacent target points among the plurality of target points to encircle a target area corresponding to the target supplier in the service scenario.

12. The method according to claim 7, wherein determining a target area corresponding to the target supplier in the service scenario based on the target distance comprises:
obtaining, by the at least one processor, a circular area with the target supplier as a center and the target distance as a radius; and
taking, by the at least one processor, the circular area as the target distance corresponding to the target supplier in the service scenario.

13. (canceled)

14. A non-transitory computer-readable storage medium storing a computer program, wherein when the computer program is executed by a processor, the processor is caused to perform operations comprising:
determining a trigger condition corresponding to each of a plurality of preset service scenarios for a target supplier;
in response to determining that the trigger condition corresponding to any one of the service scenarios is satisfied, determining a target area corresponding to the target supplier in the service scenario; and
switching a service coverage area of the target supplier to the target area.

15. An electronic device, comprising a memory, a processor, and a computer program stored on the memory and executable on the processor, wherein when the processor executes the program, the processor is cause to perform operations comprising:
determining a trigger condition corresponding to each of a plurality of preset service scenarios for a target supplier;
in response to determining that the trigger condition corresponding to any one of the service scenarios is satisfied, determining a target area corresponding to the target supplier in the service scenario; and
switching a service coverage area of the target supplier to the target area.

16. The electronic device according to claim 15, wherein the operations further comprise:
in response to the preset service scenarios comprising a first service scenario and a second service scenario, determining, according to a first curve, a first trigger condition corresponding to the first service scenario and a second trigger condition corresponding to the second service scenario, the first curve being a curve of a load of a delivery resource for a service order in a preset area at which the target supplier is located over time.

17. The electronic device according to claim 16, wherein the preset service scenarios further comprise a third service scenario, and a third trigger condition corresponding to the third service scenario is that a preset instruction is received.

18. The electronic device according to claim 16, wherein determining, according to a first curve, a first trigger condition corresponding to the first service scenario and a second trigger condition corresponding to the second service scenario comprises:
determining the first curve;
determining a first moment and a second moment based on the first curve, the first moment being a moment at which a load is smaller than a preset threshold for the first time after a preset moment in the first curve, and the second moment being a moment at which the load is greater than the preset threshold for the first time after the first moment in the first curve;
determining arrival of the first moment as the first trigger condition corresponding to the first service scenario; and
determining arrival of the second moment as the second trigger condition corresponding to the second service scenario.

19. The electronic device according to claim 18, wherein the operations further comprise:
fitting a second curve based on historical service data in the preset area at which the target supplier is located, the second curve being a relationship curve between the load and a delivery duration; and
determining a load corresponding to the first delivery duration in the second curve as the preset threshold.

20. The electronic device according to claim 18, wherein a first target area corresponding to the target supplier in the first service scenario is larger than a second target area corresponding to the target supplier in the second service scenario.

21. The electronic device according to claim 17, wherein determining a target area corresponding to the target supplier in the service scenario comprises:
determining a target distance corresponding to the target supplier in the service scenario; and
determining a target area corresponding to the target supplier in the service scenario based on the target distance.
